(19) United States
(12) Patent Application Publication
(10) Pub. No.: US 2025/0224768 A1
(43) Pub. Date: Jul. 10, 2025

(54) CASE WITH REMOVABLE ENDPIECE FOR PORTABLE ELECTRONIC DEVICE AND METHODS OF USING

(71) Applicant: National Products, Inc., Seattle, WA (US)

(72) Inventor: Jeffrey D. Carnevali, Seattle, WA (US)

(21) Appl. No.: 18/404,795

(22) Filed: Jan. 4, 2024

(51) Int. Cl. G06F 1/16

(52) U.S. Cl. CPC G06F 1/1632; G06F 1/1656; G06F 1/1679

(57) ABSTRACT

A case for a portable electronic device includes a shell having a back panel, a front panel, and at least one side wall. The back panel, front panel, and side wall(s) define a cavity for receiving the portable electronic device and a side opening between the back panel and the front panel for insertion of the portable electronic device. The case further includes a removable endpiece having a base and, optionally, an adapter, which includes a male plug for insertion into a female port of the portable electronic device, a contactor opposite the male plug, first contacts disposed on the male plug, and second contacts disposed on the contactor and electrically coupled to the first contacts. The removable endpiece is configured for insertion through the side opening into the cavity and between the front panel and the back panel for engagement with, and retention of, the portable electronic device.

### FIELD OF THE INVENTION

The present invention relates generally to a case for a portable electronic device and methods of using. The present invention is also directed to a portable electronic device case with a removable endpiece and methods of using.

### BACKGROUND OF THE INVENTION

Mobile devices, such as smartphones, cellular or mobile phones, tablets, personal data assistants, and other portable devices, are now ubiquitous. Cases are typically used to protect the mobile device.

### SUMMARY OF THE INVENTION

One embodiment is a case for a portable electronic device that includes a shell having a back panel, a front panel opposite the back panel and defining a closed perimeter of a window, and at least one side wall extending between the back panel and the front panel, wherein the back panel, front panel, and at least one side wall define a cavity for receiving and holding the portable electronic device within the shell and further define a side opening, separate from the window, between the back panel and the front panel for insertion of the portable electronic device through the side opening into the cavity. The case further includes a removable endpiece having a base and an adapter coupled to the base, the adapter includes a male plug configured for insertion into a female port of the portable electronic device, a contactor opposite the male plug, a plurality of first contacts disposed on the male plug, and a plurality of second contacts disposed on the contactor and electrically coupled to the first contacts, wherein the removable endpiece is configured for, after insertion of the portable electronic device, insertion through the side opening into the cavity and between the front panel and the back panel for engagement with, and retention of, the portable electronic device within the cavity.

Another embodiment is a case for a portable electronic device. The case includes a shell having a back panel, a front panel opposite the back panel and defining a closed perimeter of a window, and at least one side wall extending between the back panel and the front panel, wherein the back panel, front panel, and at least one side wall define a cavity for receiving and holding the portable electronic device within the shell and further define a side opening, separate from the window, between the back panel and the front panel for insertion of the portable electronic device through the side opening into the cavity. The case also includes a removable endpiece having includes a base and an adapter coupled to the base, the adapter includes a male plug configured for insertion into a female port of the portable electronic device, a contactor opposite the male plug, a plurality of first contacts disposed on the male plug, and a plurality of second contacts disposed on the contactor and electrically coupled to the first contacts, wherein at least 50% of a volume of the removable endpiece is configured for insertion through the side opening into the cavity for engagement with, and retention of, the portable electronic device within the cavity.

Yet another embodiment is a case for a portable electronic device. The case includes a shell having a back panel, a front panel opposite the back panel and defining a closed perimeter of a window, and at least one side wall extending between the back panel and the front panel, wherein the back panel, front panel, and at least one side wall define a cavity for receiving and holding the portable electronic device within the shell and further define a side opening, separate from the window, between the back panel and the front panel for insertion of the portable electronic device through the side opening into the cavity. The case also includes a removable endpiece configured for, after insertion of the portable electronic device, insertion through the side opening into the cavity and between the front panel and the back panel for engagement with, and retention of, the portable electronic device within the cavity.

In at least some embodiments, the removable endpiece is configured for, after insertion of the portable electronic device, insertion through the side opening so that at least 50%, 60%, 70%, 75%, 80%, 90%, 95%, 99%, or 100% of the volume of the removable endpiece is disposed in the cavity. In at least some embodiments, wherein, when inserted into the cavity after insertion of the portable electronic device, no portion of the removable endpiece is exposed through the window. In at least some embodiments, wherein, when inserted into the cavity after insertion of the portable electronic device, no portion of the removable endpiece, except the male plug, is disposed in a region of the cavity that is below the window.

In at least some embodiments, an entirety of the base of the removable endpiece is configured for insertion through the side opening into the cavity. In at least some embodiments, an entirety of the base of the removable endpiece is configured for insertion through the side opening and disposition between the front panel and the back panel.

In at least some embodiments, the contactor includes a male positioning interface extending away from the base with the second contacts disposed on the male positioning interface. In at least some embodiments, the contactor comprises a female positioning interface recessed with respect to a surface of the base with the second contacts disposed on the female positioning interface. In at least some embodiments, a surface of the contactor, at which the second contacts are exposed, is flush with a surface of the base.

In at least some embodiments, the removable endpiece further includes a female connector spaced apart from the contactor, the female connector including a plurality of third contacts electrically coupled to the first contacts. In at least some embodiments, the case further includes at least one fastener for fastening the removable endpiece to the shell.

A further embodiment is an arrangement that includes any of the cases described above and the portable electronic device configured for insertion into the case.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a top perspective view of one embodiment of a case with a shell and a removable endpiece in a disassembled form, according to the invention;

FIG. 1B is a top perspective view of the case of FIG. 1A with a portable electronic device partially inserted through a side opening into a cavity defined by the shell, according to the invention;

FIG. 1C is a top perspective view of the case of FIG. 1A with the portable electronic device fully inserted and the removable endpiece inserted into the shell, according to the invention;

FIG. 2A is a front perspective view of one embodiment of a removable endpiece, according to the invention;

FIG. 2B is a rear perspective view of the removable endpiece of FIG. 2A, according to the invention;

FIG. 3 is a block diagram illustrating electrical contacting of the portable electronic device to an adapter and female connector of a removable endpiece, according to the invention;

FIG. 4A is a top perspective view of the case of FIG. 1A with a portable electronic device and a docking cradle, according to the invention;

FIG. 4B is a back perspective view of the case and docking cradle of FIG. 4A, according to the invention;

FIG. 5 is a top perspective view of another embodiment of a case with a shell and a removable endpiece, according to the invention;

FIG. 6A is a top perspective view of a third embodiment of a case with a shell and a removable endpiece, according to the invention; and

FIG. 6B is a top perspective view of a fourth embodiment of a case with a shell and a removable endpiece, according to the invention.

### DETAILED DESCRIPTION OF PREFERRED EMBODIMENT

The present invention relates generally to a case for a portable electronic device and methods of using. The present invention is also directed to a portable electronic device case with a removable endpiece and methods of using.

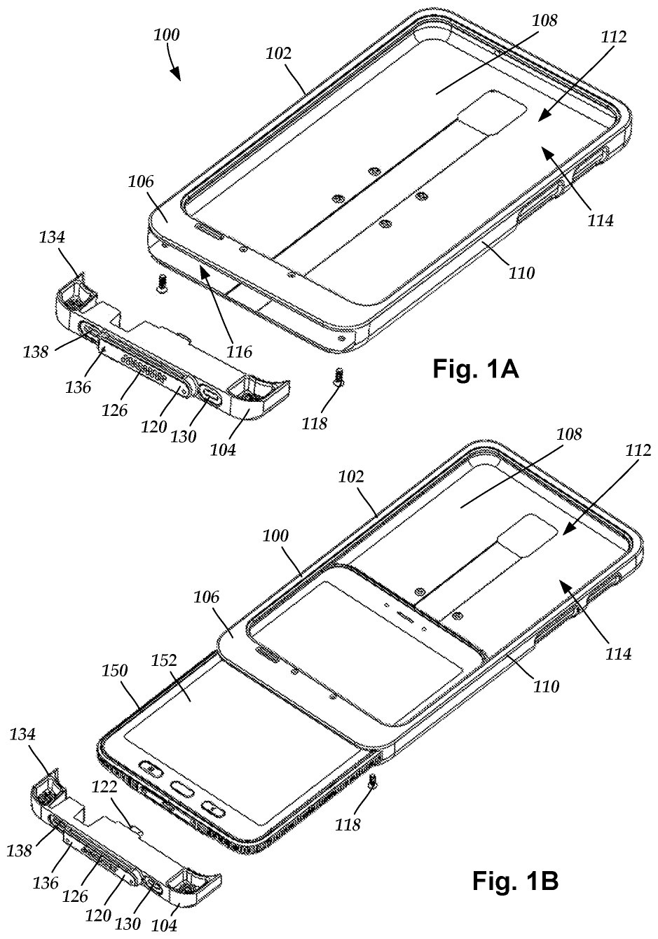

FIGS. 1A, 1B, and 1C illustrate one embodiment of a case 100 for a portable electronic device 150. The case 100 can be designed for a variety of different portable electronic devices 150 including, but not limited to, mobile phones, cellular phones, tablets, laptop computers, personal digital assistants, or the like or any other suitable portable electronic device.

The case 100 includes a shell 102 and a removable endpiece 104. The shell 102 has a front panel 106, a back panel 108, and at least one side wall 110, all of which define a cavity 112 for receiving the portable electronic device 150. The front panel 106 also defines a window 114 through which the screen 152 of the portable electronic device 150 can be viewed. The shell 102 has a side opening 116 (for example, a side opening at the bottom of the case 100) to the cavity 112. The portable electronic device 150 is inserted through the side opening 116 into the cavity of the shell 102, as illustrated in FIG. 1B, instead of insertion through the window 114 as occurs for many conventional cases. The side opening 116 is positioned between the front panel 106 and the back panel 108.

The shell 102 can be made of a flexible material or a rigid material or any combination thereof. The removable endpiece 104 can be made of a rigid material or a combination of rigid material and flexible material. Examples of flexible materials include, but are not limited to, thermoplastic elastomeric polymer materials, other suitable flexible or elastomeric polymer materials, or the like or any combination thereof. Examples of rigid materials include, but are not limited to, rigid plastics, metal, or the like or any combination thereof.

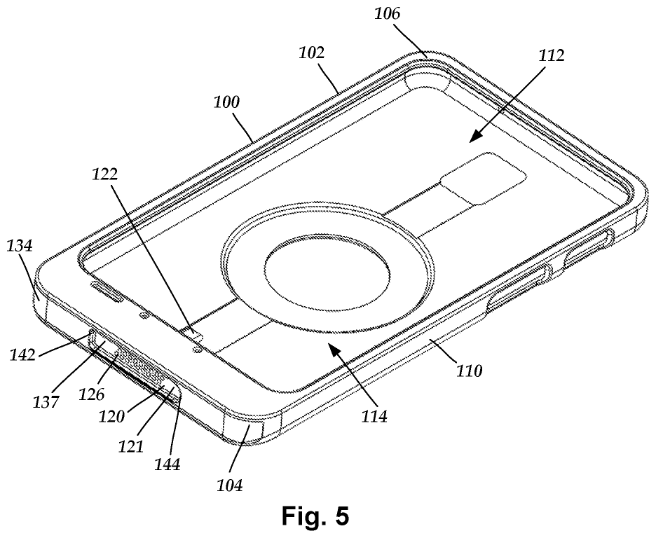

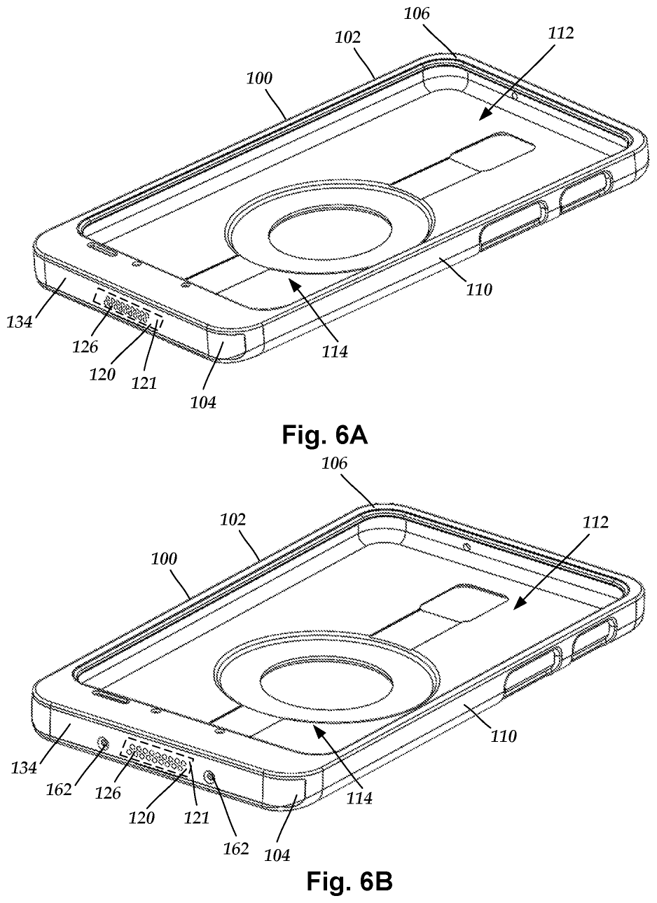

After inserting the portal electronic device 150 into the cavity 112 through the side opening 116, at least a portion of the removable endpiece 104 is inserted through the side opening 116 into the cavity 112 for engagement with, and retention of, the portable electronic device within the cavity. The removable endpiece 104 acts as a plug for the cavity 112 to prevent or hinder the portable electronic device 150 from falling out of the cavity. In at least some embodiments, at least 50%, 60%, 70%, 75%, 80%, 90%, 95%, 99%, or 100% (i.e., the entirety) of the volume of the removable endpiece 104 is inserted through the side opening 116 and into the cavity 112. In at least some of these embodiments, the remainder of the removable endpiece 104 extends outside of the cavity 112. In at least some embodiments, at least 50%, 60%, 70%, 75%, 80%, 90%, 95%, 99%, or 100% (i.e., the entirety) of the volume of the removable endpiece 104 is disposed between the front panel 106 and the back panel 108. In at least some embodiments, when inserted into the cavity 112 after insertion of the portable electronic device 150, the entirety of the removable endpiece 104 is disposed within the cavity 112 or disposed entirely between the front panel 106 and back panel the 108 (see, for example, FIGS. 5, 6A, and 6B). In at least some embodiment, when inserted into the cavity 112 after insertion of the portable electronic device 150, no portion of the removable endpiece 104 is exposed through the window 114. In at least some embodiment, when inserted into the cavity 112 after insertion of the portable electronic device 150, no portion of the removable endpiece 104, except the male plug 122 (described below), extends into a region of the cavity 112 that is below, or defined by, the window 114.

In at least some embodiments, the case 100 includes one or more fasteners 118 for attachment of the removable endpiece 104 to the shell 102. Examples of fasteners 118 include, but are not limited to, one or more screws, one or more bolts, one or more pins, one or more clips, one or more magnets in both the shell 102 and the removable endpiece 104, one or more magnets in the shell 102 or removable endpiece 104 (or both) and one or more components containing magnetically attracted material (e.g., ferromagnetic material) in the removable endpiece or the shell (or both), or the like or any combination thereof. In at least some embodiments, the shell 102 and the removable endpiece 104 include holes 140 for receiving a fastener 118, such as, for example, a screw, bolt, or pin. In at least some embodiments, the holes 140 in one, or both, of the shell 102 and the removable endpiece 104 are threaded. In at least some embodiments, the shell 102 and the removable endpiece 104 include any other suitable attachment arrangement such as, but not limited to, a ridge/detent arrangement (for example, at least one ridge on the shell 102 or removable endpiece 104 (or both) and at least one detent on the removable endpiece or the shell (or both)), a tab/depression arrangement (for example, at least one tab on the shell 102 or removable endpiece 104 (or both) and at least one depression on the removable endpiece or the shell (or both) to receive and retain a tab), or the like or any combination of thereof or any combination of these arrangements and fasteners.

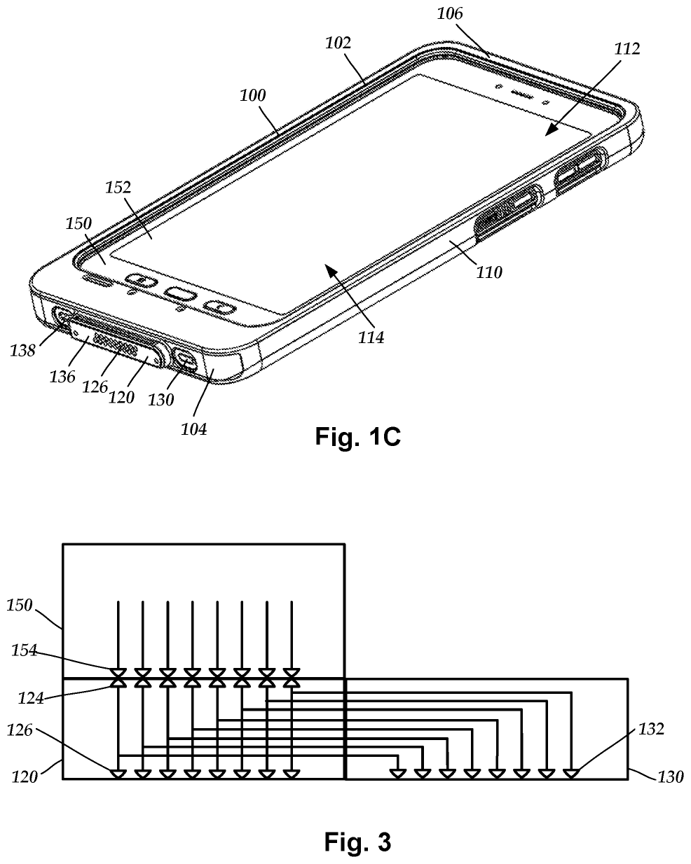

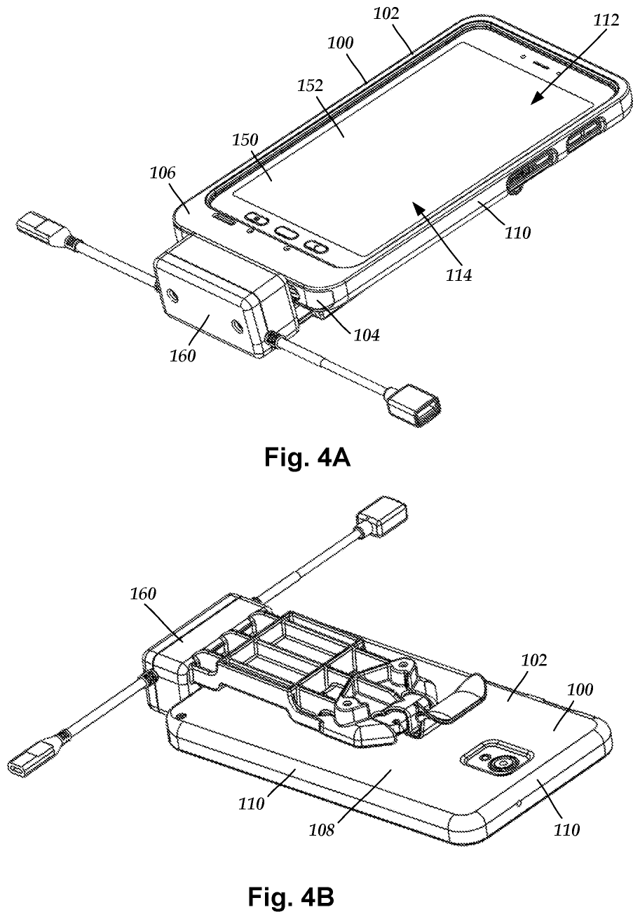

FIGS. 2A and 2B illustrate one embodiment of the removable endpiece 104. The removable endpiece 104 includes a base 134 and an adapter 120 coupled to the base 134. In at least some embodiments, a portion of the adapter 120 is embedded in the base 134. The adapter 120 is configured for coupling the case 100 and the portable electronic device 150 to an external device, a docking cradle 160 (see, FIGS. 4A and 4B), or other docking arrangement.

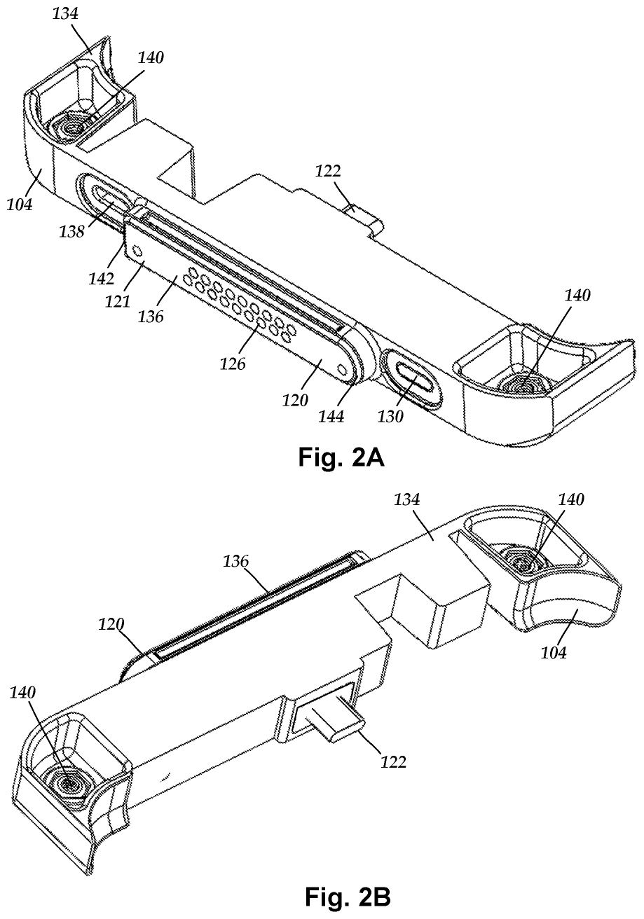

The adapter 120 includes a male plug 122 for insertion into a female socket of the portable electronic device 150, a contactor 121 opposite the male plug 122, first contacts 124 (FIG. 3) disposed on the male plug for electrically coupling to device contacts 154 (FIG. 3) of the portable electronic device, and second contacts 126 disposed on the contactor 121 for coupling the portable electronic device to an external device, a docking cradle 160 (see, FIGS. 4A and 4B), or other docking arrangement. The first contacts 124 on the male plug 122 are electrically coupled to the second contacts 126 (for example, by wires or traces on a printed circuit board or any combination thereof) so that the adapter can carry power or data or both between an external device and the portable electronic device.

In at least some embodiments, the contactor 121 has a flat surface upon which the second contacts 126 are exposed, as illustrated in FIG. 2A. In at least some embodiments, the flat surface of the contactor 121 is perpendicular to the direction that the male plug 122 extends. In at least some embodiments, the flat surface of the contactor 121 is parallel to the adjacent surface of the base 134, as illustrated in FIG. 2A. In at least some embodiments, the second contacts 126 are circular. In at least some embodiments, the second contacts 126 are arranged in at least two rows of contacts. In at least some embodiments, the two rows are offset from each other. Any other suitable arrangement or type of contacts or contactor can be used.

In at least some embodiments, the adapter 120 forms a male structure 136 extending out of the base 134 for coupling to a female connector (not shown) or any other suitable connector of an external device, a docking cradle 160 (see, FIGS. 4A and 4B), or other docking arrangement. In at least some embodiments, the male structure 136 can have an asymmetric shape that can facilitate correctly coupling the case 100 to the external device, docking cradle 160 (see, FIGS. 4A and 4B), or other docking arrangement. In the embodiment illustrated in FIGS. 2A and 2B, the male structure 136 has a first edge 142 that is straight and a second edge 144, opposite the first edge, that is curved. A female connector of the external device, docking cradle 160 (see, FIGS. 4A and 4B), or other docking arrangement can be shaped similarly to the male structure 136 so that the male structure 136 of the case only fits easily into the female connector of the external device, docking cradle 160 (FIGS. 4A and 4B), or other docking arrangement in one orientation. This asymmetry of some embodiments of the male structure 136 of the case 100 facilitates correct coupling of the case with the external device, docking cradle 160 (FIGS. 4A and 4B), or other docking arrangement so that the second contacts 126 correctly and reliably mate with corresponding contacts on the external device, docking cradle 160 (FIGS. 4A and 4B), or other docking arrangement.

In at least some embodiments, the adapter 120 forms a female structure 137 (i.e., a recessed structure) extending inward relative to the base 134 for coupling to a male connector (not shown) or any other suitable connector of an external device, a docking cradle 160 (see, FIGS. 4A and 4B), or other docking arrangement, as illustrated in FIG. 5. In at least some embodiments, the female structure 137 can have an asymmetric shape that can facilitate correctly coupling the case 100 to the external device, docking cradle 160 (see, FIGS. 4A and 4B), or other docking arrangement. In the embodiment illustrated in FIG. 5, the female structure 137 has a first edge 142 that is straight and a second edge 144, opposite the first edge, that is curved. A male connector of the external device, docking cradle 160 (see, FIGS. 4A and 4B), or other docking arrangement can be shaped similarly to the female structure 137 so that the female structure 137 of the case only fits easily into the female connector of the external device, docking cradle 160 (FIGS. 4A and 4B), or other docking arrangement in one orientation. This asymmetry of some embodiments of the female structure 137 of the case 100 facilitates correct coupling of the case with the external device, docking cradle 160 (FIGS. 4A and 4B), or other docking arrangement so that the second contacts 126 correctly and reliably mate with corresponding contacts on the external device, docking cradle 160 (FIGS. 4A and 4B), or other docking arrangement.

In at least some embodiments, the contactor 121 of the adapter 120 is flush with a surface of the base 134 of the removable endpiece 104, as illustrated in FIGS. 6A and 6B. In at least some embodiments, adjacent surfaces of the contactor 121 and base 134 can appear to be uniform and not visually distinct, other than the presence of the second contacts 126, as illustrated in FIGS. 6A and 6B. In at least some embodiments, the contactor 121 or the base 134 includes one or more locating features, such as locating holes 162 or locating pins (not shown), for locating the case 100 relative to an external device, docking cradle 160 (FIGS. 4A and 4B), or other docking arrangement, which includes complementary locating features (for example, locating pins or locating holes, respectively), as illustrated in FIG. 6B.

In at least some embodiments, the removable endpiece 104 or the adapter 120 includes a female connector 130, such as a USB-A, USB-B, USB-C, Micro-USB, Mini-USB, or Lightning connector or the like. In at least some embodiments, the female connector 130 is spaced apart from the male structure 136 or contactor 121 or both. The female connector 130 includes third contacts 132 (FIG. 3) that are electrically coupled to the first contacts 124 (for example, by wires or traces on a printed circuit board or any combination thereof).

In at least some embodiments, the removable endpiece 104 also includes a port 138. In at least some embodiments, the port 138 can be similar in size and shape to the female connector 130 and the case 100 can include a plug (not shown) that can fit snugly in either the port or the female connector. The plug (not shown) may be useful to cover the female connector 130 when not in use. When the female connector 130 is in use, the plug (not shown) can be inserted into the port 138 so that it is not lost.

FIGS. 4A and 4B illustrate the case 100 disposed in, or otherwise attached to, a docking cradle 160. Non-limiting examples of external devices, docking cradles, and other docking arrangements that can be used with the case 100, as well as the connector of the external device, docking cradle or other docking arrangement, can be found in U.S. Pat. Nos. 9,195,279; 9,331,444; 9,529,387; 9,602,639; 9,632,535; 9,706,026; 9,831,904; 10,050,658; 10,054,984; 10,389,399; 10,454,515; 10,630,334; 11,029,731; 11,076,032; 11,277,506; 11,489,350; and 11,652,326; U.S. Patent Application Publications Nos. 2022/0253097; 2023/0045485; and 2023/0341897; and U.S. patent application Ser. Nos. 18/141,291 and 18/233,218, all of which are incorporated herein by reference in their entireties.

Examples of cases 100 for a portable electronic device 150 that can be modified to include the removable endpiece 104 are described in U.S. Pat. Nos. 9,195,279; 9,331,444; 9,529,387; 9,602,639; 9,632,535; 9,706,026; 10,050,658; 10,054,984; 10,389,399; 10,454,515; 10,630,334; 10,666,309; 10,778,275 10,812,643; 11,029,731; 11,076,032; 11,165,458; 11,277,506; and 11,289,864 and U.S. patent application Ser. No. 17/978,597, all of which are incorporated herein by reference in their entireties.

The above specification provides a description of the structure, manufacture, and use of the invention. Since many embodiments of the invention can be made without departing from the spirit and scope of the invention, the invention also resides in the claims hereinafter appended.

What is claimed is:

1. A case for a portable electronic device, the case comprising:
a shell comprising a back panel, a front panel opposite the back panel and defining a closed perimeter of a window, and at least one side wall extending between the back panel and the front panel, wherein the back panel, front panel, and at least one side wall define a cavity for receiving and holding the portable electronic device within the shell and further define a side opening, separate from the window, between the back panel and the front panel for insertion of the portable electronic device through the side opening into the cavity; and
a removable endpiece comprising a base and an adapter coupled to the base, the adapter comprises a male plug configured for insertion into a female port of the portable electronic device, a contactor opposite the male plug, a plurality of first contacts disposed on the male plug, and a plurality of second contacts disposed on the contactor and electrically coupled to the first contacts, wherein the removable endpiece is configured for, after insertion of the portable electronic device, insertion through the side opening into the cavity and between the front panel and the back panel for engagement with, and retention of, the portable electronic device within the cavity.

2. The case of claim 1, wherein the removable endpiece is configured for, after insertion of the portable electronic device, insertion through the side opening so that at least 50% of the volume of the removable endpiece is disposed in the cavity.

3. The case of claim 1, wherein, when inserted into the cavity after insertion of the portable electronic device, no portion of the removable endpiece is exposed through the window.

4. The case of claim 1, wherein, when inserted into the cavity after insertion of the portable electronic device, no portion of the removable endpiece, except the male plug, is disposed in a region of the cavity that is below the window.

5. The case of claim 1, wherein an entirety of the base of the removable endpiece is configured for insertion through the side opening into the cavity.

6. The case of claim 1, wherein an entirety of the base of the removable endpiece is configured for insertion through the side opening and disposition between the front panel and the back panel.

7. The case of claim 1, wherein the contactor comprises a male positioning interface extending away from the base with the second contacts disposed on the male positioning interface.

8. The case of claim 1, wherein the contactor comprises a female positioning interface recessed with respect to a surface of the base with the second contacts disposed on the female positioning interface.

9. The case of claim 1, wherein a surface of the contactor, at which the second contacts are exposed, is flush with a surface of the base.

10. The case of claim 1, wherein the removable endpiece further comprises a female connector spaced apart from the contactor, the female connector comprising a plurality of third contacts electrically coupled to the first contacts.

11. The case of claim 1, further comprising at least one fastener for fastening the removable endpiece to the shell.

12. An arrangement, comprising:
the case of claim 1; and
the portable electronic device configured for insertion into the case.

13. A case for a portable electronic device, the case comprising:
a shell comprising a back panel, a front panel opposite the back panel and defining a closed perimeter of a window, and at least one side wall extending between the back panel and the front panel, wherein the back panel, front panel, and at least one side wall define a cavity for receiving and holding the portable electronic device within the shell and further define a side opening, separate from the window, between the back panel and the front panel for insertion of the portable electronic device through the side opening into the cavity; and
a removable endpiece comprising comprises a base and an adapter coupled to the base, the adapter comprises a male plug configured for insertion into a female port of the portable electronic device, a contactor opposite the male plug, a plurality of first contacts disposed on the male plug, and a plurality of second contacts disposed on the contactor and electrically coupled to the first contacts, wherein at least 50% of a volume of the removable endpiece is configured for insertion through the side opening into the cavity for engagement with, and retention of, the portable electronic device within the cavity.

14. The case of claim 13, wherein at least 80% of the volume of the removable endpiece is configured for insertion through the side opening into the cavity for engagement with, and retention of, the portable electronic device within the cavity.

15. The case of claim 13, further comprising at least one fastener for fastening the removable endpiece to the shell.

16. An arrangement, comprising:
the case of claim 13; and
the portable electronic device configured for insertion into the case.

17. A case for a portable electronic device, the case comprising:
a shell comprising a back panel, a front panel opposite the back panel and defining a closed perimeter of a window, and at least one side wall extending between the back panel and the front panel, wherein the back panel, front panel, and at least one side wall define a cavity for receiving and holding the portable electronic device within the shell and further define a side opening, separate from the window, between the back panel and the front panel for insertion of the portable electronic device through the side opening into the cavity; and
a removable endpiece configured for, after insertion of the portable electronic device, insertion through the side opening into the cavity and between the front panel and the back panel for engagement with, and retention of, the portable electronic device within the cavity.

18. The case of claim 17, wherein the removable endpiece is configured for, after insertion of the portable electronic device, insertion through the side opening so that at least 50% of the volume of the removable endpiece is disposed in the cavity.

19. The case of claim 17, further comprising at least one fastener for fastening the removable endpiece to the shell.

20. An arrangement, comprising:
the case of claim 17; and
the portable electronic device configured for insertion into the case.
